(19) United States
(12) Patent Application Publication
(10) Pub. No.: US 2024/0375974 A1
(43) Pub. Date: Nov. 14, 2024

(54) SYSTEMS AND METHODS FOR PRODUCTION OF CALCIUM OXIDE WITH CONTROLLED SILICATE CONVERSION AND RESULTANT CALCIUM OXIDE COMPOSITION

(71) Applicant: Mississippi Lime Company, St. Louis, MO (US)

(72) Inventors: Kory M. Mueller, Cape Girardeau, MO (US); Martin L. Gran, Chesterfield, MO (US); Michael Stever, Arnold, MO (US); James C. Lee, Farmington, MO (US); Elizabeth J. Vitale, St. Louis, MO (US)

(21) Appl. No.: 18/662,089

(22) Filed: May 13, 2024

Related U.S. Application Data
(60) Provisional application No. 63/466,158, filed on May 12, 2023.

(51) Int. Cl. C01F 11/06; C01B 33/24

(52) U.S. Cl. CPC C01F 11/06; C01B 33/24; C01P 2006/80

(57) ABSTRACT

Systems and methods for controlling and selecting the ratio of calcium silicate to silicon dioxide in a resultant calcium oxide product produced from naturally occurring limestone including silicon materials. Moreover, processing of these calcium oxides into calcium hydroxides (hydrated lime) typically reflects the relative ratios of the feed calcium oxide so as to incorporate the adjusted ratio.

### CROSS REFERENCE TO RELATED APPLICATION(S)

This application claims the benefit of U.S. Provisional Patent Application Ser. No. 63/466,158, filed May 12, 2023, the entire disclosure of which is herein incorporated by reference.

### BACKGROUND OF THE INVENTION

### Field of the Invention

This disclosure relates to the production of calcium oxide (quicklime). More specifically, to the production of calcium oxide from naturally occurring sources of calcium carbonate (typically limestone) where the amount of silicon oxides converted to calcium silicates is controlled making the calcium oxide more or less suitable for certain applications.

### Description of the Related Art

Calcium oxide (CaO), which is commonly referred to as quicklime (or even just lime), is an incredibly useful compound with a storied history in a variety of industrial applications in all sorts of areas. Exemplary uses for calcium oxide range from many years ago where calcium oxide was heated to produce stage lighting (where the term “lime light” comes from) and as a building mortar for stone structures, to more modern uses where calcium oxide is an essential component of building materials such as cement, concrete, and plaster. Quicklime may also be used in agriculture to condition soils by reducing their acidity and increasing their pH levels and can be used in areas such as water treatment and other treatment processes as a way to remove impurities and contaminants.

The production of calcium oxide is a relatively straight-forward process and lime compounds have traditionally been manufactured according to a commonly known and utilized processes. Calcium oxide has been typically produced by thermally decomposing limestone or seashells, each of which contains sufficient levels of calcium carbonate (CaCO₃) to be commercially viable. The thermal decomposition of calcium carbonate may also be referred to as a lime burning process or calcination and occurs when a lime feed (limestone) is heated in a lime kiln to a temperature above 825° C. where calcium oxide (commonly known as quicklime) is formed in accordance with the following formula:

CaCO₃ (s)→CaO (s)+CO₂ (g)

Once formed, quicklime may then be crushed, pulverized or segregated by size to produce particulate products appropriate for the desired use.

A key aspect of the process is the kiln which both acts to provide the specific temperature for the thermal decomposition and specifics as to handling and processing of the initial calcium carbonate and resultant calcium oxide. While there are a huge number of different lime kilns, some of near ancient origins and others of contemporary design, most industrial processes use one of only a relatively small number of different designs. The design of a given lime kiln is often selected based on desired output and available input, as certain types of lime kilns are better for producing calcium oxide with certain qualities and characteristics and/or for operating on certain kinds of limestone feed stocks.

In addition to being useful itself, calcium oxide can also be used to produce calcium hydroxide, which is another useful compound. Calcium hydroxide may be used industrially as a flocculent in various processes including water and sewage treatment and for the scrubbing of acid gases from exhaust gas streams.

To produce calcium hydroxide, quicklime meeting desired size requirements is fed into a hydrator, where the calcium oxide reacts with water (also known as slaking), and then quickly dried to form calcium hydroxide in accordance with the following equation:

CaO+H₂O→Ca(OH)₂

The resultant calcium hydroxide (also known as hydrated lime) is then again typically milled and classified until it meets a desired level of fineness or surface area for the target process.

In the production of calcium oxide and calcium hydroxide, the input is rarely pure and the output material typically is not either. Instead, naturally occurring sources of calcium carbonate, particularly in the form of limestone, typically include other materials which are effectively impurities. Impurities in the source limestone are typically carried with the material into the various calcination and slaking processes where the material either remains as an impurity in its original form, or may be converted via the calcination and/or slaking process into a new material which is also an impurity.

Source impurities can be present for a variety of reasons but are often unavoidable due to the natural formation of limestone deposits as a geological process. Silicon oxides are a common impurity in many forms of commercial grade limestone used in the production of calcium oxide. The concentration and nature of the silicon oxides, which can be in a variety of different forms and structures, will typically vary by deposit, but among the common forms are silicon dioxides or silica (SiO₂—often in the form of quartz or cristobalite) and silicates such as calcium silicate (Ca₂(SiO₄)).

In a native limestone material, the specific types of material, size of the silicon oxide grains and/or crystals and their dispersion throughout the limestone matrix are a product of the formation of the limestone deposit and out of the control of any commercial process other than by selection of the actual limestone deposit, which is often simply not commercially feasible. As such, knowing, much less controlling, the ratios of silicon dioxide to calcium silicate to calcium carbonate within a source material is often not achievable to any meaningful degree for any reasonable cost. Further, control of specific forms, location, and structure of any of those materials is typically even less controllable. The problem is compounded when source material is mined from different locations, even within the same deposit, as changes in geologic structure can alter the ratios over time or space often in unknown amounts.

Silicon, while somewhat dependent on form, is generally considered an impurity in commercial limestone and is generally undesirable in the raw limestone material as well as resultant calcium oxides and hydroxides This is the case with both silica and silicates. However, the exact nature of the silicon species in the initial material and those evolved by the various commercial processes can have substantial impacts on how and how well the resultant calcium material works in any commercial applications. Some uses for calcium oxide should work better if silicon is in the form of silicon dioxide while other uses should work better if the silicon is in the form of calcium silicate. One concern is also the reactivity of calcium oxide with silica. At high temperatures, the basic calcium oxide species may react with acidic silica species to from new impurities which incorporate the calcium oxide unit. These reactions indicate that an increased presence of silica in the raw limestone that is fed into the kiln can reduce the amount of calcium oxide in a resultant product even if the presence of different silicon materials is otherwise meaningless.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, disclosed herein are systems and methods for controlling and selecting the ratio of calcium silicate to silicon dioxide in a resultant calcium oxide product produced from naturally occurring limestone including silicon materials. Moreover, processing of these calcium oxides into calcium hydroxides (hydrated lime) typically reflects the relative ratios of the feed calcium oxide so as to incorporate the adjusted ratio.

Described herein, among other things, are systems and methods of controlling the production of calcium silicate, such systems and methods comprising: obtaining a calcium carbonate source in the form of a naturally occurring limestone, the calcium carbonate source including a first amount of silicon dioxide; selecting a target amount of calcium oxide to be obtained from thermal decomposition of calcium carbonate in the calcium carbonate source; calcining a portion of the calcium carbonate source at a temperature of 950° C. or higher to obtain a high ratio portion wherein in the high ratio portion at least 85% of the total silicate content is calcium silicate and the high ratio portion includes the target amount of calcium oxide; and calcining a portion of the calcium carbonate source at a temperature of 900° C. or lower to obtain a low ratio portion wherein in the low ratio portion no more than 30% of the total silicate content is calcium silicate and the low ratio portion includes the target amount of calcium oxide.

In an embodiment the method further comprises, hydrating the high ratio portion to produce calcium hydroxide from the target amount of calcium oxide.

In an embodiment of the method, after the hydrating at least 85% of the total silicate content is calcium silicate

In an embodiment of the method, after the hydrating, the calcium hydroxide in the high ratio portion is reacted with lithium carbonate.

In an embodiment the method further comprises, hydrating the high ratio portion to produce calcium hydroxide from the target amount of calcium oxide.

In an embodiment of the method, after the hydrating no more than 30% of the total silicate content is calcium silicate.

In an embodiment of the method, after the hydrating, the calcium hydroxide in the low ratio portion is reacted with lithium carbonate.

In an embodiment of the method, the low ratio portion is used in the preparation of calcium salts and calcium sulfonate detergents

In an embodiment of the method, the low ratio portion is used for in-flight flue gas reaction.

In an embodiment of the method, the low ratio portion is used as a feed for the production of a material that undergoes an air or turbine classification process.

In an embodiment of the method, the high ratio portion is ejected into atmospheric air as a waste product of a later process.

In an embodiment of the method, the high ratio portion is less abrasive than the low ratio portion.

### BRIEF DESCRIPTION OF THE DRAWINGS

FIG. 1 provides a table showing results of a pilot kiln study investigating the effects of calcination time and temperature on the concentration of impurities, and specifically calcium silicate, in a resulting calcium oxide product.

FIG. 2 provides a table illustrating the differences between calcium oxide products produced in gentle (A), medium (B), and aggressive (C) calcination conditions.

FIG. 3 provides a elemental map generated use a scanning electron microscope with energy dispersive spectroscopy illustrating the differences between a low silicate conversion (A) and higher silicate conversion (B) and (C) products.

FIG. 4 provides a table illustrating the differences between calcium oxide products produced in gentle (A), medium (B), and aggressive (C) calcination conditions and hydrated lime products generated from lime feeds exposed to similar processing conditions.

FIG. 5 shows the differences in soluble silicon content in lithium hydroxide solutions generated by the reaction of lithium carbonate with calcium hydroxides of different silicate conversion ratios.

### DETAILED DESCRIPTION OF THE PREFERRED EMBODIMENT(S)

The presence of silicon of any form can affect attributes of a resultant calcium oxide and calcium hydroxide materials beyond simple reduction of available calcium oxide. Various forms of silicon can alter overall purity, reaction performance, equipment wear, filterability, and safety considerations in a resultant calcium product. As such, it would be desirable, when possible, to reduce the presence of silicon in any form in limestone or resultant calcium products in a totality. However, this desire is overly simplistic as it ignores practical manufacturing realities. As silicon materials naturally occur in the limestone matrix, their removal from any resultant calcium product is often difficult. At best, removal of silicone products from resultant calcium oxides or hydroxides can result in substantial additional processing whose cost may spoil any resultant benefit from the silicon reduction. More concerning is that the presence of too much of a specific silicon material can reduce the effectiveness of the calcium products in certain applications. Further, additional processing required to remove problematic silicon compounds can create other problems for the lime composition depending on the nature of the required additional processing. For example, using a further additive to react out silicon compounds could result in alternative impurities now being produced.

It should be recognized that since limestone is a naturally occurring substance and silicon compounds also form in conjunction with limestone, the initial amount of any silicon compound, and in fact any other material which is not calcium carbonate (that is any “impurity”) from any naturally occurring limestone formation cannot be controlled. The limestone naturally contains whatever it contains. This application, however, is directed to systems and methods which alter the relative ratio of calcium silicate to silicon dioxide in a calcium oxide compound produced from any material having the same initial silicon content. That is, for any given ratio at the source, the ratio can be altered in the resultant compound depending on what type of ratio is preferred. It should also be recognized that since the amount of initial silicon compounds is unknown, the reduction across multiple different sources will tend not be characterizable except through the use of relative amounts. As a simple example, multiple different sources may all have their total silicon compounds clearly be reduced, even though the amount of reduction may vary between samples based on the amount that was initially present. For this reason, this disclosure will often be forced to rely on words of relative comparison. For example, the disclosure may have to indicate that an amount of a compound is “reduced”. This should be taken to mean that the amount present is less than it would be if the same sample had been used in systems or methods not described in the present disclosure.

It is important to recognizes that complete removal of silicon compounds from lime materials (e.g. calcium carbonate, calcium oxide, and calcium hydroxide), while a theoretic possibility or performable in a small scale lab setting, is a practicable impossibility in a real-world manufacturing process. Thus, instead of trying to just remove all silicon compounds, one option is to manipulate the identity of silicon impurities based on the intended use of the calcium product. This can allow the silicon compounds to be manipulated into forms that are less detrimental to a particular lime application. Specifically, certain calcium oxide products will benefit from having an increased ratio of silicon dioxide to calcium silicate while in other products a reduced ratio would be preferred. Even to the extent that all forms of silicon may be of concern in an application, some silicon species are still likely to present a greater concern than others.

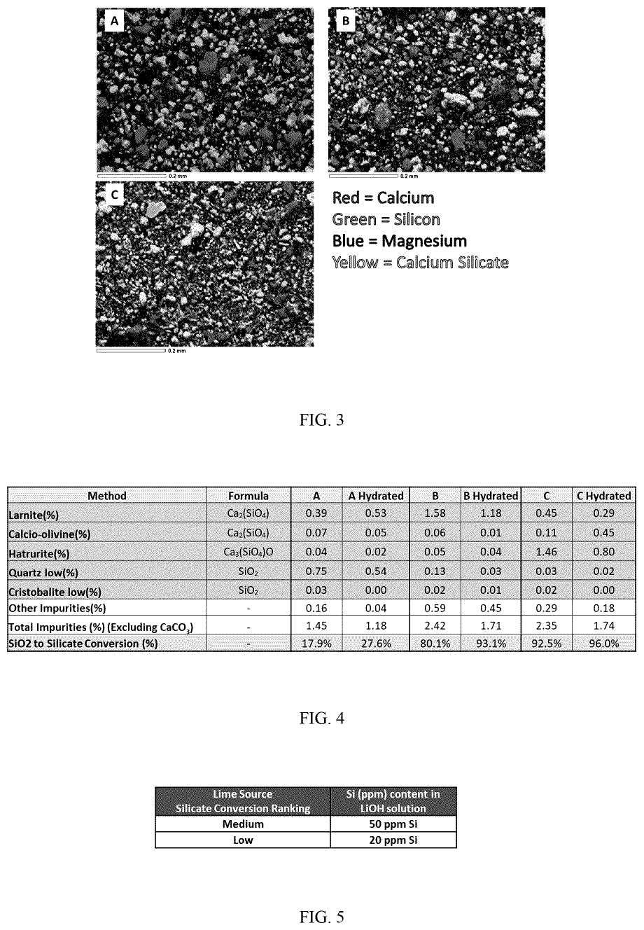

The effect of the systems and methods to convert silicon dioxide to calcium silicate is characterized in this disclosure defined as being in a “high” versus “medium” versus “low” conversion state. The varying degrees of silicate conversion, for purposes of this disclosure, are used to mean the following: A low silicate conversion product has about 30% or less of the total silicon content in the form of calcium silicates. A high silicate conversion product has about 85% or more of the total silicon content as calcium silicates. A medium silicon conversion product will fall between the low and high conversion with between about 30% and about 85% calcium silicate incorporation. However, products that fall in the low or high range, or toward either end of the medium range will generally be of more interest than products in the middle as more extreme ratios will often make resultant calcium products clearly better suited to specific applications. At the same time, there would be applications where a more balanced ratio would be desired, even if that is simply for cost savings from the processing. An example of high and low silicate conversion calcium oxide products from various production and pilot processes are shown in FIG. 2 and FIG. 3.

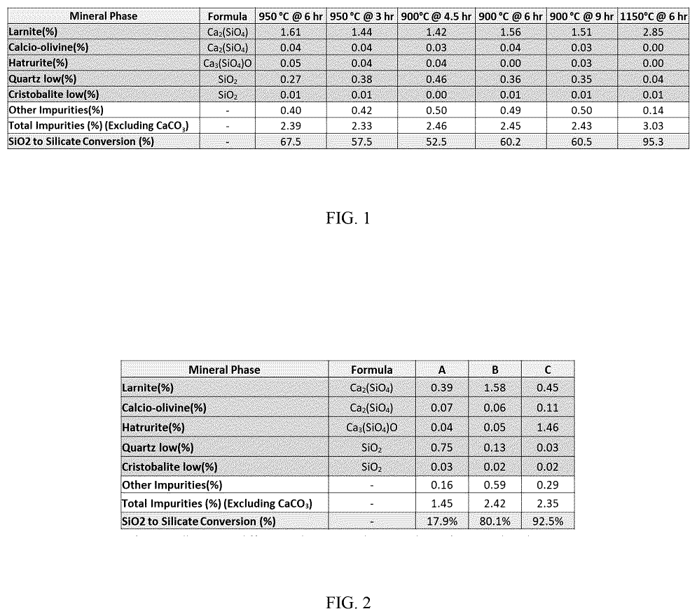

It is well known in both the fields of cement chemistry and calcium silicates that, among other variables, the concentrations of reactants, reaction temperatures, and reaction times play a critical role in the formation of calcium silicate materials of varying compositions. However, the duration and temperature of limestone's calcination and conversion to calcium oxide can be adjusted based on kiln design and calcination conditions. Specifically, exceptionally gentle calcination conditions results in a lower conversion of crystalline SiO₂ to calcium silicate. Conversely, higher calcination temperatures and longer calcination times increases the amount of SiO₂ converted into calcium silicate with the most aggressive temperatures incorporating more calcium into the calcium silicate matrix. An illustration of this is shown in FIG. 1 where various calcium oxide samples were prepared in a pilot kiln at various reaction times and temperatures. Capitalizing on this principle, it is possible to manipulate the residence time and temperature of limestone calcination through judicious kiln design and process control to influence the silicate conversion for a targeted calcium oxide product.

The calcination process may be carried out by many different methods known in the field of the art. Examples include, but are not limited to, rotary kilns, vertical shaft kilns including parallel regenerative flow kilns and single shaft kilns, rotary hearth kilns (e.g. Calcimatic), flash calciners, and fluidized bed kilns. In practice, specific kilns may be suited to generate a specific degree of silicate conversion. As an example, single shaft kilns capable of reaching exceedingly high temperatures may be used to drive the silicate conversion in the lime to near completion resulting in calcium oxide products with a very high percentage of calcium silicate compared to silicon dioxide thus producing a “high” product via the above definition. Conversely, a gentle calcination that occurs at both low temperatures and low residence times may be used to minimize silicate conversion within the lime to generate a low calcium silicate product with a higher amount of silicon dioxide of a “low” product via the above definitions.

Expanding upon the production of a silicate conversion-controlled product, reacting a silicate-controlled product with the appropriate amount of water, the composition of the resulting calcium hydroxide reflects the incoming ratio of calcium silicate to silica of the feed. In this way, it is possible to extend the control of the calcium oxide feed to that of the hydrated lime product. Generally, an identical ratio will not be maintained through the steps of hydration, but the relative “high” versus “low” conversion ratio will typically be maintained or even caused by the hydration process. An illustration is shown in FIG. 4. It should also be recognized that the presence of silicon dioxide during a hydrating reaction could result in the formation of alternative calcium silicates which could potentially alter or control both overall and relative ratios of different forms of calcium silicate as well as to somewhat alter the ratio of a calcium hydroxide product to the input calcium oxide.

Capitalizing on the silicate conversion control allows for the tailoring of ratios to address the needs of various applications for the resulting calcium oxide and calcium hydroxide compositions. While the following are merely exemplary applications and is by no means intended to be a comprehensive list, it can provide good working examples of how tailoring is useful.

Low calcium silicate product can have particular use for enhanced filtration in chemical processes such as for use in the preparation of calcium salts, calcium sulfonate detergents, etc. In particular, granules of crystalline silicon dioxide are believed to induce less clogging of filtration media than granules of calcium silicate. Further, low calcium silicate materials are also particularly useful where a higher percentage of calcium oxide is needed (as calcium oxide is not lost to calcium silicate formation). This can be in applications where the speed of a calcium oxide reaction is paramount such as in-flight flue gas reactions and similar applications. By avoiding conversion of the silicon dioxide to calcium silicate, more calcium from the limestone is available for later chemical reaction with another material which will typically increase the speed (or completeness) of such a reaction.

A low calcium silicate product can also work well as a feed for the production of finely divided materials that undergo air or turbine classification processes in an effort to increase purity. Specifically, crystalline SiO₂ surviving processing would be expected to have an increased tendency to segregate in momentum-based separation processes resulting in a more efficient removal. This would be useful, for example, to generate a hydrated lime product with a reduced total silicon content as silicon can be more easily separated.

On the other side, high calcium silicate products will have reduced crystalline silicon dioxide. Crystalline silicon dioxide is a known carcinogen when encountered in a respirable state. Calcium silicate, however, is typically much safer. Using reaction conditions to promote the conversion reaction to calcium silicate could be capitalized on to generate a safer product in applications where inhalation of the calcium product may be unavoidable or where the calcium product will be ejected into atmospheric air as a waste product. Further, silicon dioxide is typically much harder than calcium silicate and is often used as an abrasive. Thus, reduction of silicon dioxide can be particularly valuable in applications where damage to sensitive structures can readily occur.

Returning to low calcium silicate applications, calcium silicates are inherently more soluble than crystalline SiO₂ phases resulting in less aqueous silicate ions. This could be of particular advantage in applications where the resulting solution phase contains the desired product. More specifically, this may have implications for the production of lithium hydroxide (LiOH) for use in battery applications.

A traditional method in industry of generating battery grade lithium hydroxide is to react lithium carbonate with calcium hydroxide to generate a solution of lithium hydroxide while the resultant calcium carbonate precipitates out of solution. This is done according to the following chemical reaction:

Li₂CO₃+Ca(OH)₂→2LiOH+CaCO₃.

The solids are then removed from this mixture and further purification and crystallization steps are performed to purify the lithium hydroxide from the water-soluble impurities ultimately generating solid lithium hydroxide in either the anhydrous or monohydrate state. As such, it is expected that a reduction in the amount of water-soluble impurities compared to insoluble impurities (which are easily removed prior to the purification steps), such as soluble silicon species from the lime source, should positively impact the conversion process and reduce the burden on the purification and crystallization systems. In effect, if silicon dioxide can be maintained through the calcination and slaking steps as silicon dioxide and not reacted, the silicon dioxide can be easily removed during intended use of the resultant calcium hydroxide compound.

To test the impact of the present systems and methods, medium and low conversion quicklime products prepared from similar feeds but with different calcination conditions were slaked to generate a corresponding calcium hydroxide material. Each of these were tested in the lithium hydroxide conversion reaction to see how the silicate conversion effected resulting lithium purity.

Initially, limestone from a common batch (to standardize the relative abundances of starting silicon materials between the two samples) was crushed and calcinated. The first sample was calcinated at a higher temperature and for a longer time to produce a medium conversion material. The second sample was calcinated at lower temperature to produce a low conversion material. The resultant calcium oxide percentage in both batches is believed to be generally the same. Both calcium oxide samples were slaked according to the proportions and conditions prescribed in ASTM C110—Section 11 for high calcium quicklime (100 grams of CaO to 400 mL of deionized water conditioned to 25° C.). The slaked lime was allowed to mix for 20 minutes resulting in calcium hydroxide slurries of 21.1% solids for both products as measured via thermogravimetric analysis. These slurries were used for the lithium hydroxide conversion reaction as prepared.

The lithium hydroxide conversion reaction was carried out by mixing Li₂CO₃ (9.03 g) in 700 mL of deionized water at room temperature in a polyethylene reaction vessel followed by 20 minutes of stirring. At 20 minutes, stoichiometric amounts of Ca(OH)₂ (9.02 g dry Ca(OH)₂, 42.7 g Ca(OH)₂ slurry) was added via syringe to the reaction vessel. The reaction was allowed to proceed with stirring for 180 minutes at which point the mixture was centrifuged and the solution decanted to remove all solids. The lithium hydroxide solution was then subjected to ICP-OES analysis to determine soluble silicate content. The low silicate conversion quicklime showed 40% of the total soluble silicon content observed in the medium conversion quicklime (FIG. 5).

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “parallel” are purely geometric constructs and no real-world component or relationship is truly “parallel” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A method of controlling the production of calcium silicate, the method comprising:
obtaining a calcium carbonate source in the form of a naturally occurring limestone, the calcium carbonate source including a first amount of silicon dioxide;
selecting a target amount of calcium oxide to be obtained from thermal decomposition of calcium carbonate in said calcium carbonate source;
calcining a portion of said calcium carbonate source at a temperature of 950° C. or higher to obtain a high ratio portion wherein in said high ratio portion at least 85% of the total silicate content is calcium silicate and said high ratio portion includes said target amount of calcium oxide; and
calcining a portion of said calcium carbonate source at a temperature of 900° C. or lower to obtain a low ratio portion wherein in said low ratio portion no more than 30% of the total silicate content is calcium silicate and said low ratio portion includes said target amount of calcium oxide.

2. The method of claim 1 further comprising, hydrating said high ratio portion to produce calcium hydroxide from said target amount of calcium oxide.

3. The method of claim 2 wherein after said hydrating at least 85% of the total silicate content is calcium silicate.

4. The method of claim 3 wherein after said hydrating, said calcium hydroxide in said high ratio portion is reacted with lithium carbonate.

5. The method of claim 1 further comprising, hydrating said high ratio portion to produce calcium hydroxide from said target amount of calcium oxide.

6. The method of claim 5 wherein after said hydrating no more than 30% of the total silicate content is calcium silicate.

7. The method of claim 6 wherein after said hydrating, said calcium hydroxide in said low ratio portion is reacted with lithium carbonate.

8. The method of claim 1 wherein said low ratio portion is used in the preparation of calcium salts and calcium sulfonate detergents.

9. The method of claim 1 wherein said low ratio portion is used for in-flight flue gas reaction.

10. The method of claim 1 wherein said low ratio portion is used as a feed for the production of a material that undergoes an air or turbine classification process.

11. The method of claim 1 wherein said high ratio portion is ejected into atmospheric air as a waste product of a later process.

12. The method of claim 1 wherein said high ratio portion is less abrasive than said low ratio portion.
